(19) United States
(12) Patent Application Publication
(10) Pub. No.: US 2024/0109378 A1
(43) Pub. Date: Apr. 4, 2024

(54) MODULAR TIRE PRESSURE LEAK DETECTION SYSTEM

(71) Applicant: The Goodyear Tire & Rubber Company, Akron, OH (US)

(72) Inventors: Adam William Birdsall, Hudson, OH (US); Jing Xue, Hudson, OH (US); Mirko Aurelio Ledda, Saint-Vincent (BE); Cary Duane Marr, Canton, OH (US); Brian Richard Morris, Canton, OH (US); Micah John Thorn, Canton, OH (US)

(21) Appl. No.: 18/457,383

(22) Filed: Aug. 29, 2023

Related U.S. Application Data
(60) Provisional application No. 63/377,736, filed on Sep. 30, 2022.

(51) Int. Cl. B60C 23/04

(52) U.S. Cl. CPC B60C 23/0484; B60C 23/0416; B60C 23/0476

(57) ABSTRACT

A modular tire pressure leak detection system includes a tire that supports a vehicle and a sensor unit mounted on the tire. The sensor unit detects real-time tire parameters inside the tire and transmits the parameters to a processor. A plurality of modules are in electronic communication with the processor. The plurality of modules include a pre-processing module that receives the parameters and applies a set of operations to generate pressure time series data, a leak detection module that receives the pressure time series data and determines a leak rate of the tire, and a post-processing module that receives the leak rate of the tire and analyzes the leak rate of the tire with determinations from a plurality of conditions. A leak alert is issued by the post-processing module based upon the analysis of the leak rate of the tire and the determinations from the plurality of conditions.

### FIELD OF THE INVENTION

The invention relates generally to tire monitoring systems. More particularly, the invention relates to systems that monitor conditions in a tire, such as tire pressure. Specifically, the invention is directed to a modular system that determines when a leak of tire pressure occurs and when to issue an alert regarding the leak.

### BACKGROUND OF THE INVENTION

Vehicles include two or more axles that are supported by pneumatic tires. Typically, at least one tire is mounted on each end of each axle. Such tires typically have certain conditions or parameters that are beneficial to monitor during vehicle operation. For example, monitoring the pressure of a pneumatic tire may be helpful in assessing the condition and/or performance of the tire, as a low pressure may indicate that there is an issue with the tire.

To monitor tire pressure, Tire Pressure Monitoring Systems (TPMS) have been developed. A TPMS measures the pressure inside the tire cavity using sensors that are attached to the tire, and typically obtains pressure data in real time from the sensors. Such sensors may be attached to the interior of the tire or to the valve stem of the tire, which is in fluid communication with the tire cavity.

The pressure that is measured by the TPMS may be correlated to a specific tire and transmitted to an electronic control system of the vehicle. The measured tire pressure data may then be employed to improve the function of vehicle systems, such as an anti-lock brake system (ABS), electronic stability control system (ECS), and the like. The measured tire pressure data may also be sent to an operator of the vehicle.

In addition, for fleets of commercial vehicles or passenger vehicles, it is desirable for a manager of the fleet to be informed of tire pressure to make informed decisions about the tires and the vehicle. For example, in the event that a pressure measurement is below a threshold value, an alert may be sent to the fleet manager. The fleet manager may then instruct the vehicle operator to reduce the vehicle speed, direct the vehicle to a service center, and/or schedule an inspection of the tire.

It is desirable to improve the accuracy of pressure measurements in a TPMS, and to determine optimum conditions for the TPMS to generate an alert.

As a result, there is a need in the art for a leak detection system that determines with precision if an air pressure leak in tire is present, and when to issue an alert.

### SUMMARY OF THE INVENTION

According to an aspect of an exemplary embodiment of the invention, a modular tire pressure leak detection system is provided. The system includes a tire that supports a vehicle and a sensor unit mounted on the tire. The sensor unit detects real-time tire parameters inside the tire and transmits the parameters to a processor. A plurality of modules are in electronic communication with the processor. The plurality of modules include a pre-processing module that receives the parameters and applies a set of operations to generate pressure time series data. The plurality of modules also include a leak detection module that receives the pressure time series data and determines a leak rate of the tire. The plurality of modules further includes a post-processing module that receives the leak rate of the tire and analyzes the leak rate of the tire with determinations from a plurality of conditions. A leak alert is issued by the post-processing module based upon the analysis of the leak rate of the tire and the determinations from the plurality of conditions.

### BRIEF DESCRIPTION OF THE DRAWINGS

The invention will be described by way of example and with reference to the accompanying drawings, in which:

FIG. 1 is a schematic side elevational view of a vehicle with tires that employ an exemplary embodiment of the modular tire pressure leak detection system of the present invention;

FIG. 2 is an enlarged perspective view of a tire shown in FIG. 1, with a fragmentary representation of the vehicle shown in FIG. 1;

FIG. 3 is a schematic elevational side view of the vehicle shown in FIG. 1 with a representation of data transmission to a cloud-based server and to a display device;

FIG. 4 is a flow diagram of an exemplary embodiment of the modular tire pressure leak detection system of the present invention; and

FIG. 5 is a graphical representation of an aspect of the modular tire pressure leak detection system shown in FIG. 4.

Similar numerals refer to similar parts throughout the drawings.

### Definitions

“Axial” and “axially” means lines or directions that are parallel to the axis of rotation of the tire.
“Bead” means that part of the tire comprising an annular tensile member wrapped by ply cords and shaped, with or without other reinforcement elements such as flippers, chippers, apexes, toe guards and chafers, to fit the design rim.
“CAN bus” is an abbreviation for controller area network, as used in reference to the CAN bus system of a vehicle.
“Carcass” means the tire structure apart from the belt structure, tread, undertread, and sidewall rubber over the plies, but including the beads.
“Circumferential” means lines or directions extending along the perimeter of the surface of the annular tread perpendicular to the axial direction.
“Equatorial centerplane (CP)” means the plane perpendicular to the tire's axis of rotation and passing through the center of the tread.
“Footprint” means the contact patch or area of contact created by the tire tread with a flat surface as the tire rotates or rolls.
“Inboard side” means the side of the tire nearest the vehicle when the tire is mounted on a wheel and the wheel is mounted on the vehicle.
“Innerliner” means the layer or layers of elastomer or other material that form the inside surface of a tubeless tire and that contain the inflating fluid within the tire.
“Lateral” means an axial direction.
“Outboard side” means the side of the tire farthest away from the vehicle when the tire is mounted on a wheel and the wheel is mounted on the vehicle.
“Radial” and “radially” means directions radially toward or away from the axis of rotation of the tire.
“Rib” means a circumferentially extending strip of rubber on the tread which is defined by at least one circumferential groove and either a second such groove or a lateral edge, the strip being laterally undivided by full-depth grooves.
“Tread element” or “traction element” means a rib or a block element defined by a shape having adjacent grooves.
“TPMS” is an abbreviation for tire pressure monitoring system.

### DETAILED DESCRIPTION OF THE INVENTION

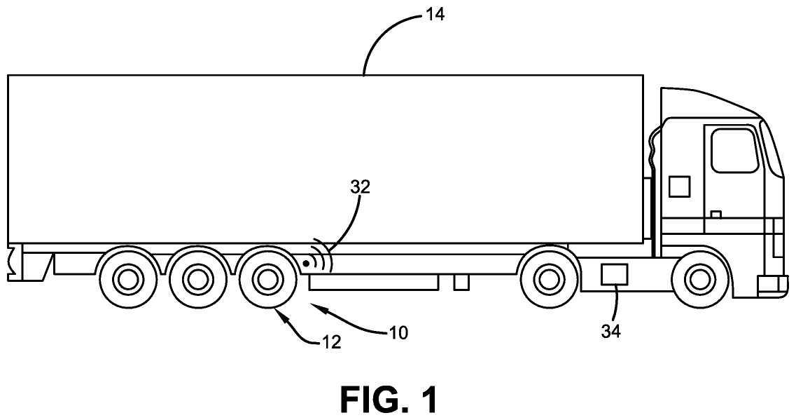

Turning now to FIGS. 1 through 5, an exemplary embodiment of a modular tire pressure leak detection system of the present invention is indicated at 10. By way of background, as shown in FIG. 1, the modular tire pressure leak detection system 10 is employed in association with tires 12 supporting a vehicle 14. While the vehicle 14 is depicted as a commercial truck, the invention is not to be so restricted. The principles of the invention find application in other vehicle categories such as passenger cars, other commercial vehicles, off-the-road vehicles, and the like, in which vehicles may be supported by more or fewer tires. In addition, the invention finds application in a single vehicle 14 or in fleets of vehicles.

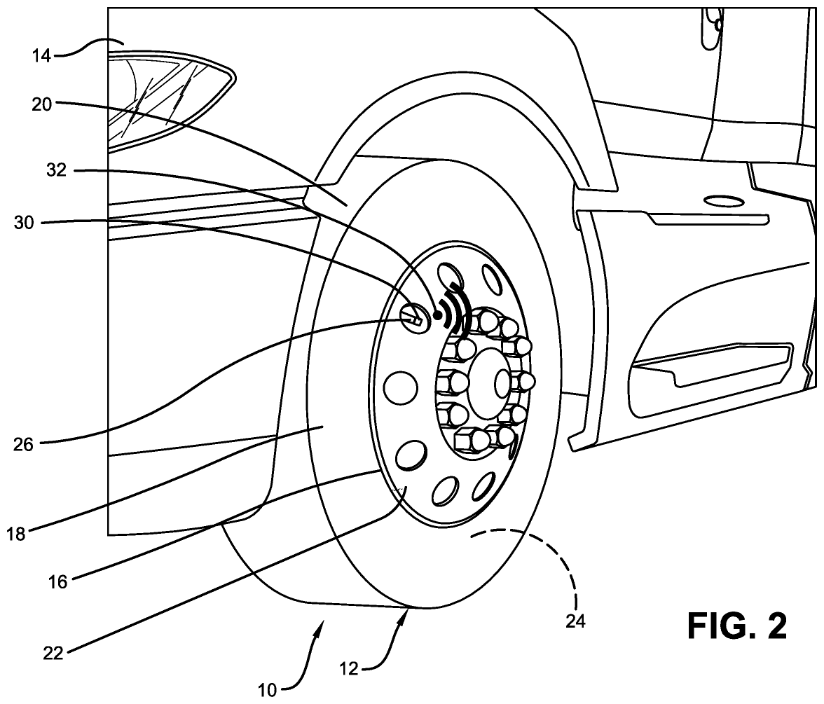

Turning to FIG. 2, each tire 12 includes a pair of bead areas 16 (only one shown) and a bead core (not shown) embedded in each bead area. Each one of a pair of sidewalls 18 (only one shown) extends radially outward from a respective bead area 16 to a ground-contacting tread 20. The tire 12 is reinforced by a carcass (not shown) that toroidally extends from one bead area 16 to the other bead area, as known to those skilled in the art. An innerliner (not shown) is formed on the inside surface of the carcass. The tire 12 is mounted on a wheel 22 in a manner known to those skilled in the art and, when mounted, forms an internal cavity 24 that is filled with a pressurized fluid, such as air.

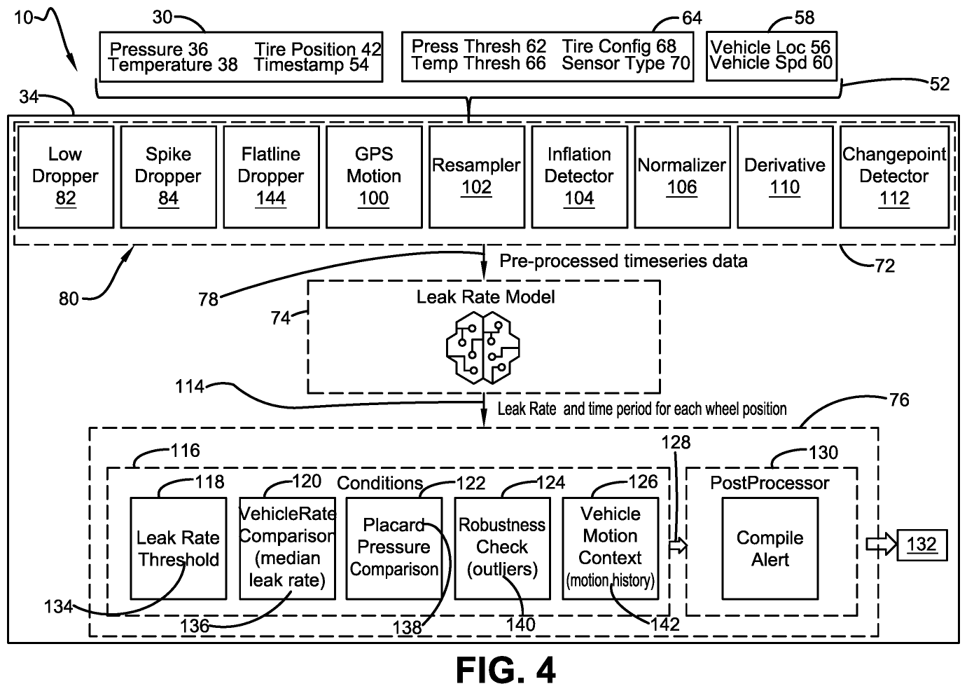

A valve stem 26 is in fluid communication with the cavity 24 and controls air flow into the cavity, as known to those skilled in the art. A sensor unit 30 is mounted on each tire 12 and includes one or more sensors for detecting certain real-time tire parameters inside the tire, such as tire pressure 36 (FIG. 4) and temperature 38. Preferably the sensor unit 30 is a tire pressure monitoring system (TPMS) module or sensor, of a type that is commercially available, and may be of any known configuration. The sensor unit 30, referred to as a TPMS sensor, may be mounted on the valve stem 26, as shown in FIG. 2. Alternatively, the TPMS sensor 30 may be attached to the interior of the tire 12.

Each TPMS sensor 30 preferably also includes electronic memory capacity for storing identification (ID) information for each tire 12, known as tire ID information. The tire ID information may include a position 42 of the tire 12 on the vehicle 14, tire type, tire construction, and the like. Alternatively, tire ID information may be included in another sensor unit, or in a separate tire ID storage medium, such as a tire ID tag (not shown). With additional reference to FIG. 1, the TPMS sensor 30 includes an antenna for wireless transmission 32 of the measured tire pressure and temperature data, as well as tire ID data, to a processor 34.

The processor 34 may be mounted on the vehicle 14 as shown in FIG. 1, or may be integrated into the TPMS sensor 30. Alternatively, the processor 34 may be a local processor disposed in a fleet management facility computer. For the purpose of convenience, the processor 34 will be described as being mounted on the vehicle 14, with the understanding that the processor may alternatively be integrated into the TPMS sensor 30 or may alternatively be disposed in a fleet management facility computer. Preferably, the processor 34 is in electronic communication with or integrated into an electronic system of the vehicle 14, such as the vehicle CAN bus system, which is referred to as the CAN bus.

Aspects of the modular tire pressure leak detection system 10 preferably are executed on the processor 34 or on another processor that is accessible through the vehicle CAN bus, which enables input of data from the TMPS sensor 30, as well as input of data from other sensors that are in electronic communication with the CAN bus. In this manner, the modular tire pressure leak detection system 10 enables direct measurement of tire pressure 36 with the TPMS sensor 30, which preferably is transmitted to the processor 34.

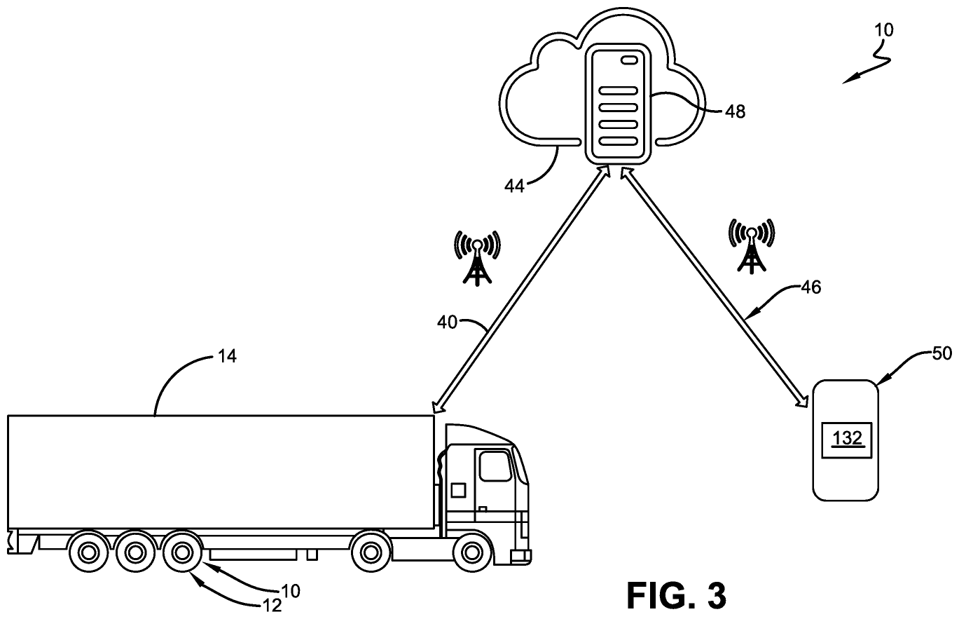

Referring to FIG. 3, aspects of the modular tire pressure leak detection system 10 may be executed on a remote processor 48. For example, data such as the measured tire pressure 36, temperature 38, measurement time and ID information may be wirelessly transmitted 40 from the processor 34 and/or the CAN bus on the vehicle 14 to the remote processor 48, which may be a processor in a cloud-based server 44. Alternatively, the remote processor 48 may be disposed in a fleet management facility computer. For the purpose of convenience, the remote processor 48 will be described as being disposed in a cloud-based server 44, with the understanding that the remote processor may alternatively be disposed in a fleet management facility computer. The cloud-based server 44 preferably executes aspects of the modular tire pressure leak detection system 10, which will be described in greater detail below. Output from the system 10 may be wirelessly transmitted 46 to a display device 50. The display device 50 may include a device that is accessible to a user of the vehicle 14, such as a smartphone, and/or a device that is accessible to a fleet manager, such as a computer.

Turning to FIG. 4, the modular tire pressure leak detection system 10 receives input data 52 for each tire 12 and/or the vehicle 14, which is electronically communicated or transmitted to the processor 34. The input data 52 preferably includes the tire pressure 36 from the TPMS sensor 30, the tire temperature 38 from the TPMS sensor, and a measurement time or timestamp 54 from the TPMS sensor. In addition, the input data 52 preferably includes a position of the tire 12 on the vehicle 14, which is known as a tire position 42, from the tire ID information, which may be from the TPMS sensor 30. The input data 52 preferably also includes a location 56 of the vehicle 14, preferably from a global positioning system (GPS) 58 that is in electronic communication with the processor 34, such as through the CAN bus, and a speed 60 of the vehicle 14 from the GPS.

The input data 52 further preferably includes a pressure threshold 62. The pressure threshold 62 may include a placard pressure 138, which is the tire inflation pressure value denoted by a vehicle manufacturer and is typically included on a placard mounted on the vehicle 14 in a location that is visible to a user. The pressure threshold 62 may be stored in an electronic memory 64 that is in electronic communication with the processor 34 or which may be included in the tire ID information. The input data 52 preferably also includes a temperature threshold 66 that is stored in the electronic memory 64. The input data 52 preferably further includes a tire configuration 68 for the vehicle 14 that is stored in the electronic memory 64, and a TPMS sensor type 70 that is stored in the electronic memory or which may be available from the TPMS sensor 30.

The modular tire pressure leak detection system 10 includes three (3) modules that are stored on or are in electronic communication with the processor 34, including a pre-processing module 72, a leak detection module 74, and a post-processing module 76. The pre-processing module 72 receives the input data 52 and applies a set of configurable operations 80 to isolate the most recent trend in measured pressure 36 and generate pressure time series data 78.

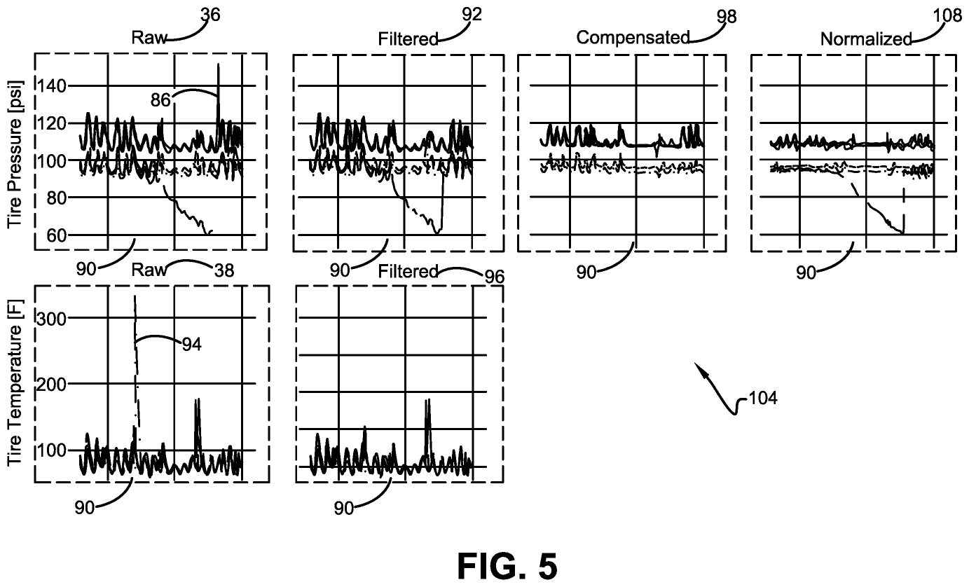

The operations 80 may include a low pressure dropper 82, which drops measured pressure values 36 when the sensor 30 is removed from or not mounted in the tire 12. The operations 80 may also include a spike dropper 84, which removes sudden spikes 86 (FIG. 5) in the measured pressure values 36 and spikes 94 in the measured temperature values 38. Specifically, the spike dropper 84 filters out pressure spikes 86 from the measured pressure values 36 over time 90 to generate filtered pressure values 92, and filters out temperature spikes 94 from the measured temperatures values 38 over time to generate filtered temperature values 96.

The operations 80 may include a flatline dropper 144, which detects and filters out a flatline in the input data 52. Because a flatline in data typically corresponds to a malfunction of a sensor, the flatline dropper 144 enables the system 10 to refrain from employing input data 52 from a malfunctioning sensor. The operations 80 may also include a GPS annotator 100, which employs data from the GPS 58 to extract values of measured pressure 36 when the speed of the vehicle 14 is excessive or insufficient, when the acceleration of the vehicle is excessive or insufficient, and/or when the amount of time the vehicle is in motion is insufficient. The GPS annotator 100 may also filter out pressure measurements 36 taken when the vehicle 14 travels outside of a predetermined geographic region, which is known in the art as geofencing, and/or when the vehicle travels at an excessive speed. The operations 80 may also include a resampler 102, which resamples measured data from the TPMS sensor 30 to a uniform cadence, thereby improving the accuracy of the data sets.

The operations 80 may include an inflation detector 104. With additional reference to FIG. 5, the inflation detector 104 compensates the filtered pressure values 92 with the filtered temperature values 96, thus generating temperature-compensated pressure measurements 98. The inflation detector 104 may also identify and filter out any one-time step-changes in pressure 36 due to manual pressure adjustment by an operator of the vehicle 14 or a technician, thereby preventing manual, non-leak pressure adjustments from affecting the leak rate determination performed by the leak detection module 74 described below. The operations 80 may also include an operation that smooths the temperature-compensated pressure values 98, preferably using a moving average, to detect inflation of the tire 12.

With continuing reference to FIGS. 4 and 5, the operations 80 may also include a peer-based pressure normalizer 106. The normalizer 106 compares the measured pressure values 36 for a specific tire 12 to measured pressure values for other tires on the vehicle 14 (FIG. 1) to generate a peer-normalized pressure 108. The peer-normalized pressure 108 provides a reference baseline, which may be among all of the tires 12 on a specific vehicle 14, among all of the tires on a specific axle of the vehicle, or among tires having the same position on separate vehicles in a fleet. The peer-normalized pressure 108 enables uniform fluctuations of pressure 36 among tire 12 peers to be determined and deviations from the uniform fluctuations to be highlighted, which may indicate an air pressure leak.

Referring again to FIG. 4, the operations 80 may include a derivator 110, which computes derivatives of the measured pressure values 36 to improve detection of pressure change points. The operations 80 may also include a changepoint detector 112, which segments the measured pressure values 36 based on periods of time 90 and detects change points to extract a most recent linear trend from the pressure values.

Once the pre-processing module 72 has applied the configurable operations 80 to isolate the most recent trend in pressure 36, the pre-processing module outputs or generates pressure time series data 78 in which sources of changes in tire pressure, other than tire leaks, have been removed as much as possible.

The pressure time series data 78 input into the leak detection module 74. The leak detection module 74 preferably determines a leak rate 114 of the tire 12 by estimating the slope of the pressure time series data 78. Preferably, the leak detection module 74 includes a robust regressor that is employed as a timeseries model, which extracts the slope of the pressure time series data 78 as the leak rate 114. The leak rate 114 may include both a single-value point estimate of the slope of the pressure time series data 78 and a confidence range. The leak detection module 114 may also report a start and end of a period of time 90 for the input data 52.

The leak rate 114 is input into the post-processing module 76. The post-processing module 76 analyzes the leak rate 114 along with supplementary information, such as information about the state of the vehicle 14, to determine if an alert 132 should be issued. The post-processing module 76 includes a condition evaluator 116 that reviews multiple conditions through the use of sub-modules.

For example, the condition evaluator 116 may include a leak rate threshold sub-module 118 that compares the leak rate 114 to a predetermined low pressure threshold 134. If the leak rate 114 is significantly above the threshold 134, the leak rate threshold sub-module 118 may classify the leak rate as a fast leak. If the leak rate 114 is slightly above the threshold 134, the leak rate threshold sub-module 118 may classify the leak rate as a slow leak. If the leak rate 114 is at or below the threshold 134, the leak rate threshold sub-module 118 may classify the leak rate as no leak.

The condition evaluator 116 may also include a vehicle rate comparison sub-module 120, which compares the leak rate 114 to a median leak rate 136 in a group of tires 12. The median leak rate 136 preferably is a median value of the leak rates 114 for each tire 12 in a selected group of tires, which may be among all of the tires on a specific vehicle 14, among all of the tires on a specific axle of the vehicle, or among tires having the same position on separate vehicles in a fleet. The vehicle rate comparison sub-module 120 compiles the median leak rate 136 and suppresses the alert 132 if the leak rate 114 is similar to the median leak rate, as a pressure drop is likely due to driving or temperature conditions rather than a leak.

The condition evaluator 116 may include a placard pressure comparison sub-module 122. As described above, the placard pressure 138 is the tire inflation pressure value denoted by a vehicle manufacturer, which is typically included on a placard mounted on the vehicle 14 in a location that is visible to a user. Because the placard pressure 138 may be lower than the low pressure threshold 134, the placard pressure comparison sub-module 122 compares the measured pressure 36 for the tire 12 to the placard pressure and suppresses the alert 132 if the measured pressure is similar to the placard pressure.

The condition evaluator 116 may also include a robustness check sub-module 124. The robustness check sub-module 124 reviews the measured pressure data 36 to determine whether the leak rate 114 determined by the leak detection module 74 module may be disproportionately influenced by a small number of individual observations that sit outside the main trend, which may be referred to as outliers 140. When the outliers 140 exceed a predetermined amount or threshold, the robustness check sub-module 124 suppresses the alert 132.

The condition evaluator 116 may include a vehicle motion context sub-module 126. The vehicle motion context sub-module 126 checks a motion history 142 of the vehicle 14 to determine if the leak rate 114 is consistent with the vehicle motion history. For example, if the motion history 142 indicates typical movement of the vehicle 14, an alert 132 may not be suppressed. Alternatively, if there is a sudden change in the leak rate 114 for a vehicle 14 that has been stationary for a long period of time, the leak may be inconsistent with the motion history 142 of the vehicle, and the vehicle motion context sub-module 126 suppresses the alert 132.

Determinations 128 from the sub-modules of the condition evaluator 116 are input into a postprocessor 130 of the post-processing module 76. The postprocessor 130 compares the determinations 128 from each sub-module 118, 120, 122, 124, and 126 to determine if the alert 132 should be issued. For example, if the leak rate threshold sub-module 118 classifies the leak rate 114 as a fast leak or a slow leak, one determination 128 is to issue a corresponding fast or slow leak alert 132. However, if the leak rate 114 is similar to the median leak rate 136, a determination 128 from the vehicle rate comparison sub-module 120 may be to suppress the alert 132.

In addition, if the measured pressure 36 for the tire 12 is similar to the placard pressure 138, a determination 128 from the placard pressure comparison sub-module 122 may be to suppress the alert 132. Moreover, if the outliers 140 exceed a predetermined amount or threshold, a determination 128 from the robustness check sub-module 124 may be to suppress the alert 132. Also, if the leak rate 114 is inconsistent with the motion history 142 of the vehicle 14, a determination 128 from the vehicle motion context sub-module 126 may be to suppress the alert 132.

Once the postprocessor 130 compares the determinations 128 and finds that an alert should not be suppressed, a fast or slow leak alert 132 that corresponds to the leak rate 114 is issued by the post-processing module 76. Returning to FIG. 3, when the alert 132 is issued, it may be wirelessly transmitted 46 from the cloud-based server 44 to the display device 50, which is accessible to a user of the vehicle 14 or to a fleet manager. A fleet manager viewing the display device 50 may take preventative measures, such as instructing a vehicle operator to slow the vehicle 14 down, direct the vehicle to a service center, and/or schedule the vehicle for maintenance. A user viewing the display device 50 may also take action based on the alert 132.

In this manner, the modular tire pressure leak detection system 10 of the present invention employs the pre-processing module 72, the leak detection module 74, and the post-processing module 76 to determine when a leak of pneumatic pressure from a tire 12 occurs and when to issue an alert 132 regarding the leak.

The present invention also includes a method of detecting a tire pressure leak. The method includes steps in accordance with the description that is presented above and shown in FIGS. 1 through 5.

It is to be understood that the structure of the above-described modular tire pressure leak detection system 10 may be altered or rearranged, or components or steps known to those skilled in the art omitted or added, without affecting the overall concept or operation of the invention. For example, the system 10 has been described with reference to valve stem mounted TPMS sensors, but finds application in other types of TPMS sensors that are known to those skilled in the art. In addition, the system 10 may be applied to the detection of a pressure leak in each tire 12 mounted on one vehicle 14, or to tires that are mounted on multiple vehicles in a fleet.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A modular tire pressure leak detection system comprising:
a tire supporting a vehicle;
a sensor unit mounted on the tire, the sensor unit detecting real-time tire parameters inside the tire, the sensor unit transmitting the parameters to a processor;
a plurality of modules in electronic communication with the processor, the plurality of modules including:
a pre-processing module, the pre-processing module receiving the parameters and applying a set of operations to generate pressure time series data;
a leak detection module, the leak detection module receiving the pressure time series data and determining a leak rate of the tire; and
a post-processing module, the post-processing module receiving the leak rate of the tire and analyzing the leak rate of the tire with determinations from a plurality of conditions; and
a leak alert issued by the post-processing module based upon the analysis of the leak rate of the tire and the determinations from the plurality of conditions.

2. The modular tire pressure leak detection system of claim 1, wherein the real-time parameters include a measured pressure of the tire, a measured temperature of the tire, and a measurement time.

3. The modular tire pressure leak detection system of claim 1, wherein the real-time parameters further comprise identification information for the tire, including a position of the tire on the vehicle.

4. The modular tire pressure leak detection system of claim 1, further comprising at least one of a location of the vehicle and a speed of the vehicle that are input into the pre-processing module.

5. The modular tire pressure leak detection system of claim 1, further comprising at least one of a tire pressure threshold, a tire temperature threshold, a tire configuration for the vehicle, and an identification of a type of the sensor unit that are input into the pre-processing module.

6. The modular tire pressure leak detection system of claim 1, wherein the set of operations includes a low pressure dropper that drops values of a measured pressure of the tire when the sensor unit is not mounted on the tire.

7. The modular tire pressure leak detection system of claim 1, wherein the set of operations includes a spike dropper that removes spikes in values of a measured pressure of the tire to generate filtered pressure values and removes spikes in values of a measured temperature of the tire to generate filtered temperature values.

8. The modular tire pressure leak detection system of claim 7, wherein the set of operations includes an inflation detector that compensates the filtered pressure values with the filtered temperature values to generate temperature-compensated pressure measurements.

9. The modular tire pressure leak detection system of claim 1, wherein the set of operations includes a GPS annotator that extracts values of a measured pressure related to at least one of a speed of the vehicle, an acceleration of the vehicle, an amount of time the vehicle is in motion, and a geographic region in which the vehicle travels.

10. The modular tire pressure leak detection system of claim 1, wherein the set of operations includes a resampler that resamples the real-time tire parameters from the sensor unit.

11. The modular tire pressure leak detection system of claim 1, wherein the set of operations includes a peer-based pressure normalizer that provides a reference baseline of the real-time tire parameters among a group of tires.

12. The modular tire pressure leak detection system of claim 1, wherein the set of operations includes a derivator that computes derivatives of measured pressure values to improve detection of pressure change points.

13. The modular tire pressure leak detection system of claim 1, wherein the set of operations includes a changepoint detector that segments measured pressure values based on periods of time and detects change points.

14. The modular tire pressure leak detection system of claim 1, wherein the leak detection module extracts a slope of the of the pressure time series data as the leak rate.

15. The modular tire pressure leak detection system of claim 1, wherein the post-processing module includes a condition evaluator that includes a leak rate threshold sub-module which compares the leak rate to a predetermined low pressure threshold to classify the leak rate as a fast leak or a slow leak.

16. The modular tire pressure leak detection system of claim 1, wherein the post-processing module includes a condition evaluator that includes a vehicle rate comparison sub-module which compares the leak rate to a median leak rate in a group of tires and suppresses the leak alert if the leak rate is similar to the median leak rate.

17. The modular tire pressure leak detection system of claim 1, wherein the post-processing module includes a condition evaluator that includes a placard pressure comparison sub-module which compares a measured pressure for the tire to a placard pressure and suppresses the leak alert if the measured pressure is similar to the placard pressure.

18. The modular tire pressure leak detection system of claim 1, wherein the post-processing module includes a condition evaluator that includes a robustness check sub-module which reviews measured pressure data and suppresses the leak alert when outliers in the measured pressure data exceed a predetermined threshold.

19. The modular tire pressure leak detection system of claim 1, wherein the post-processing module includes a condition evaluator that includes a vehicle motion context sub-module which checks a motion history of the vehicle and suppresses the leak alert when the leak rate is inconsistent with the motion history of the vehicle.

20. The modular tire pressure leak detection system of claim 1, wherein the post-processing module includes a postprocessor that compares the determinations as generated by sub-modules in the post-processing module to determine whether to issue the leak alert.
